(19) United States
(12) Patent Application Publication
(10) Pub. No.: US 2010/0222941 A1
(43) Pub. Date: Sep. 2, 2010

(54) Remote Control Electric Powered Skateboard

(76) Inventor: Wesley Wenti Chang, Changhua City (TW)

Correspondence Address: Jackson Intellectual Property Group PLLC, 106 Starvale Lane, Shipman, VA, 22971, US

(21) Appl. No.: 12/713,509

(22) Filed: Feb. 26, 2010

(30) Foreign Application Priority Data
Feb. 27, 2009 (TW) 98106264

(51) Int. Cl. A63C 17/12; H02P 1/18

(52) U.S. Cl. 701/2; 318/400.18; 180/181

(57) ABSTRACT

A remote control electric powered skateboard has a brushless motor or a brushless hub motor installed on the lower surface of the skateboard for connecting to a battery device through a controller, so that the motors could be electrified. A driving device disposed between either afore motors and at least one wheel is controlled by the remote control, thereby permitting an automatic comparison. When the electrification of the remote control executes, the remote control spontaneously generates an initial code for a receiver in the controller to robotically distinguish and lock the code. Turning off the remote control provides an automatic decoding. A receiver receives control signals from the remote control for the controller to interpret, and accordingly the controller generates and sends distinct commands to either motor, which allows the skateboard to implement various actions correspondingly. An auxiliary remote device disposed on the joint between a front support and a plywood is foldable or could stand on the skateboard; the height of the auxiliary remote device is adjustable for meeting divergent demands from dissimilar riders. A remote handle further provides the same operating means as that of the remote control for offering a supplementary supporting function.

### BACKGROUND OF THE INVENTION

1. Field of the Invention

The present invention relates to a remote control electric powered skateboard, in particular to a power-driven skateboard.

2. Description of the Related Art

Skateboards are a popular way for young persons to travel. Even though electric powered skateboards could be widely seen in the market, certain deficiencies are admitted in the conventional electric powered skateboards. Such remote control electric powered skateboard issued by a U.S. Pat. No. 5,893,425 includes a remote control having a movable trigger. Wherein, the movable trigger is able to emit a variable controlled acceleration signal and a variable controlled deceleration signal according to the displacement amount of the trigger. Moreover, a motor includes a motor control and a receiving device that receives the variable controlled acceleration signal and the variable controlled braking signal, so that the motor could be adjustably accelerated and braked. Herein, the moveable trigger on the remote control has a shorter movable distance, so such operation means is difficult for beginners to use. Further, the motors contained in such electric powered skateboard adopt common brush motors which possess the characteristics of the lower efficiency and shorter using life. The power further adopts a sealed lead-acid battery whose volume is bulky and whose discharge time is also short. Especially, suchlike battery is unable to sustain the large current applied in the controller of the brushless motor. As a result, the battery would adversely have a shorter using life.

### SUMMARY OF THE INVENTION

The object of the present invention is to provide a remote control electric powered skateboard that is handy to control and has a long using life. The remote control electric powered skateboard in accordance with the present invention has a board with an upper rider-support surface and a lower surface supporting a plurality of wheels. Characterized in that:

A brushless motor or a brushless hub motor installed on said lower surface of the skateboard connects to a battery device that provides either motor with a driving power therewith through a controller. A driving device is disposed between the brushless motor and at least one of the wheels. The driving device is controlled by a remote control and is able to offer an automatic comparison function: the remote control subjected to electrification allows an automatic generation of an initial code for permitting a receiver in the controller to execute the spontaneous identification and automatically lock the initial code. An automatic decoding is carried on after the remote control is shut off. The receiver receiving control signals emitted from the remote control, the controller thence decodes the signal so as to dispatch distinct commands to the brushless motor, thereby allowing various actions pursuant to the signals emitted from the remote control to be implemented by the skateboard. At least three touch switches disposed on the remote control respectively control an accelerating cruise, a decelerating cruise, and a brake of the brushless motor. Moreover, the brushless motor or the brushless hub motor utilizes an instant obverse-reverse rotation characteristic to trigger the braking motion of the brushless motor or the brushless hub motor. Namely, while a braking signal is emitted from the remote control, the controller would thence emit a counter current to the brushless motor, so that the brushless motor or the brushless hub motor would have a braking function equivalent to a reverse rotation. Alternatively, the remote control adopts a potential sliding stem to emit the control signals to the controller. The potential sliding stem includes a sliding buckle. While the sliding buckle is clutched backward by a finger, an average velocity would be provided. Moreover, the velocity of the skateboard is decided according to a displacement amount of the sliding buckle. When rider feels a specific velocity is suitable, the sliding buckle would not be clutched anymore. While the sliding buckle is moved forward to its original position, a deceleration effect would be achieved; herein, while the sliding buckle is moved frontward to a certain angle, a brake motion would be triggered, and the skateboard would be stopped in a safe short time. If rider desires to back the skateboard, the back switch on the top portion of the remote control should be triggered, and the operating means of the back motion is same as that of the forwarding motion.

In the remote driving device, at least one active wheel is connected to a synchronizing wheel on the brushless motor via a synchronizing tape. Moreover, at least one active wheel is directly connected to the brushless hub motor. The remote control, the controller, and the receiver are directed to a speed control device having a digital tuner. The remote control emits an initial code for the controller to receive and lockout, whereby permitting a one-to-one comparison to be automatically accomplished. The remote control comprises a further touch switch which serves to control a reversing of the brushless motor or the brushless hub motor. The four touch switches on the remote control are an accelerating cruise button, a decelerate button, a reverse button, and a brake button, respectively. Wherein, the accelerating cruise button controls the acceleration and cruise of the brushless motor or the brushless hub motor, the decelerating cruise button controls the deceleration and cruise of the brushless motor or the brushless hub motor, the reverse button controls the back motion of the brushless motor or the brushless hub motor, and the brake button controls the braking motion of the brushless motor or the brushless hub motor. While the accelerating cruise button is clicked, the skateboard would move with a uniform velocity. The velocity of the skateboard is decided by the clicking times on the button. As a result, while rider feels a certain velocity is suitable, the accelerating cruise button would be released, and then the operation of cruise would start. Herein, the remote control adopts the stepless speed regulation. That is, if rider continuingly presses the accelerating cruise button, the velocity of the skateboard would be steplessly increased until the desired velocity is achieved. Pressing the decelerate button would slow down the velocity, pressing the reverse button would back the skateboard, and pressing the brake button would stop the skateboard in a short time. Alternatively, a potential sliding stem on the remote control could be operated to transmit controlling signals to the controller. The potential sliding stem includes a sliding buckle whose displacement amount decides a self-velocity of the skateboard; whereby the skateboard attains an average velocity while the sliding buckle is clutched backward and a deceleration effect while the sliding buckle is moved forward to its original position; the sliding buckle moved frontward over a certain limited angle serves to trigger a brake motion, and the skateboard would be stopped in a safe short time. If rider desires to back the skateboard, the back switch disposed on the top portion of the remote control should be triggered, and thence the back motion could be achieved similar to the forwarding motion as previously described.

The brushless motor and the brushless hub motor adopt a high speed permanent magnet synchronous motor whose highest rotational speed is 950˜5100 RPM. An active wheel and a passive wheel are connected to a synchronizing wheel on the brushless motor via a synchronizing tape, and two active wheels are directly connected to the brushless hub motor. The high speed permanent magnet synchronous brushless motor or brushless hub motor possesses at least 75%˜95% horsepower energy, and 12V˜36V voltage. The controller further provides with safety assemblies including a blockage protection; namely, the skateboard is unable to move forward while any obstruction exists, so that the skateboard would be automatically stopped in a predetermined time; a dynamic phase-lacking protection; namely, while any lacked phase is detected, the skateboard would be stopped; and a fall-out prevention; namely, if any uncontrollable situation is detected, the controller would automatically perceived, and the power supply would be simultaneously cut off. The controller would automatically emit a stop signal to stop the skateboard when the controller beyond a remote-control distance fails to receive the signals from the remote control; the effective remote-control distance between the remote control and the controller is within 3 meters. A battery box is disposed on the lower surface of the skateboard. The battery box includes a bottom surface and two side surfaces. Moreover, a first groove is defined on the bottom of the battery box for intercommunicating and justly fitting with a second groove defined on the skateboard while installing the battery box. A power socket defined on the battery box connects to the controller tightly engages with a plug on the controller. A secure lock is disposed inside the battery box for preventing the battery box from sliding on the skateboard. One set of Li-ion battery is included in the battery box, and the Li-ion battery adopts the voltage of 12V˜36V.

The skateboard adopts the high speed permanent magnet synchronous brushless motor or brushless hub motor, whose highest speed achieves 5100 RPM, as well as the controller. The motor and the controller are fixed under the skateboard. In operation, rider operates the touch buttons on the remote control to dispatch divergent control signals to the controller, so that the brushless motor or the brushless hub motor could execute different working procedure. Herein, at least one rear wheel is connected to a synchronizing wheel on the brushless motor via a synchronizing tape, and at least one rear wheel is directly connected to the brushless hub motor. Finally, various stable actions could be accomplished accordingly. Four touch switches are disposed on the remote control. While the accelerating cruise button is clicked, the skateboard would move with a uniform velocity. The velocity of the skateboard is decided by the clicking times on the button. As a result, while rider feels a certain velocity is suitable, the accelerating cruise button would not be triggered anymore, and then the operation of cruise would start. Herein, the remote control adopts the stepless speed regulation. That is, if rider continuingly presses the accelerating cruise button, the velocity of the skateboard would be steplessly increased until the desired velocity is achieved. The decelerate button has a similar function to that of the accelerate button. The slight difference between abovementioned two buttons is that one is disposed for accelerating and the other is disposed for decelerating. Pressing the reverse button would back the skateboard, and pressing the brake button would stop the skateboard in a short time. The remote control and the controller are able to intercommunicate and control with each other through dual frequencies. At least two brushless motors are disposed in accordance with an active wheel and other passive wheels to collectively form a multi-driving motor system. Moreover, an electrical differential device is disposed in the controller for synchronous rotation of the four wheels.

A plywood combined with a front support defines an indentation whose center further provides with an opening. A strengthening block is fitted in the indentation, and a through hole is defined on a front section of the upper rider-support surface for being engaged with an auxiliary remote device. In structuring, a cover disposed on the through hole and the opening would be firstly removed for a base to penetrate the through hole and the opening to insert into the strengthening block. Accordingly, a locating device would be untied for an inner pipe to be stretched to an appropriate length, and after that the locating device would be fixed, so that rider could place hands on the corresponding remote handle to stand on the skateboard for operating. In folding, a join member is wound for departing from a limiting stem, so that the limiting stem could be axially moved onward. Whereby, the inner pipe brought by the outer pipe slants to the surface of the skateboard until parallelly lying thereon. If rider desires to resume the skateboard, adverse operating steps to abovementioned procedure should be adopted. As a result, the skateboard is handy for being taken along with the rider, or convenient for being accommodated. Preferably, while resuming the skateboard, the auxiliary remote device could be simply drawn out for the cover to dispose on the through hole and the opening, so that the skateboard could be controlled by the remote control.

The remote handle employs the four touch switches thereon to transmit distinct control signals to the controller. The four touch switches are the accelerating cruise button, the decelerating cruise button, the reverse button, and the brake button. Wherein, the accelerating cruise button is applied to control the acceleration and cruise of the brushless motor or the brushless hub motor, the decelerating cruise button is applied to control the deceleration and cruise of the brushless motor or the brushless hub motor, the reverse button is applied to control the backing motion of the brushless motor or the brushless hub motor, and the brake button is applied to control the braking motion of the brushless motor or the brushless hub motor. Pressing the accelerating cruise button allows the skateboard to be moved with a uniform velocity; the velocity of the skateboard is decided by the clicking times on the button. As a result, while rider feels a certain speed is suitable, the accelerating cruise button would not be triggered anymore, and then the operation of cruise would start. Herein, the remote control adopts the stepless speed regulation. That is, if rider continuingly presses the accelerating cruise button, the velocity of the skateboard would be steplessly increased until the desired velocity is achieved. Pressing the decelerate button would slow down the velocity, pressing the reverse button would back the skateboard, and pressing the brake button would stop the skateboard in a short time. The remote control adopts a potential sliding stem to emit the control signals to the controller; the potential sliding stem includes a sliding buckle whose displacement amount decides a self-velocity of the skateboard. Rider's finger triggering the buckle inwardly allows the skateboard to be moved with a uniform velocity. If a desired speed of the skateboard is reached, rider would not clutch the buckle anymore for reducing the speed thereof. Moreover, a backing motion of the skateboard could be accomplished by a reverse clutching from the rider. Thus, when the sliding buckle is moved outward to a certain angle, a brake motion of the skateboard would be triggered and the skateboard would be stopped in a short time.

### BRIEF DESCRIPTION OF THE DRAWINGS

FIG. 1 is a schematic view showing a first preferred embodiment of the present invention in using;

FIG. 2 is a perspective view showing the first preferred embodiment of the present invention;

FIGS. 3-A to 3-B are a top view and an end view respectively showing the first preferred embodiment of the present invention;

FIG. 4 is a side view showing the first preferred embodiment of the present invention;

FIG. 5 is side view showing a remote control of the present invention;

FIG. 5-A is a side view showing another remote control of the present invention;

FIG. 6 is a flowchart showing a brushless motor and a controller of the present invention;

FIG. 7 is an end view showing a transmission structure of the brushless motor of the present invention;

FIG. 8 is a schematic view showing the transmission structure of the brushless motor of the present invention;

FIG. 9 is a perspective view showing a second preferred embodiment of the present invention;

FIG. 10 is a flowchart showing a brushless hub motor and the controller of the present invention;

FIG. 11 is an exploded view showing a third preferred embodiment of the present invention;

FIG. 12 is a perspective view showing the third preferred embodiment of the present invention;

FIG. 13 is a schematic view showing the third preferred embodiment of the present invention in folding;

FIGS. 14-A and 14-B are schematic views showing a remote handle of the present invention; and

FIG. 15 is a perspective view showing the present invention combined with a cover.

### DETAILED DESCRIPTION OF THE PREFERRED EMBODIMENTS

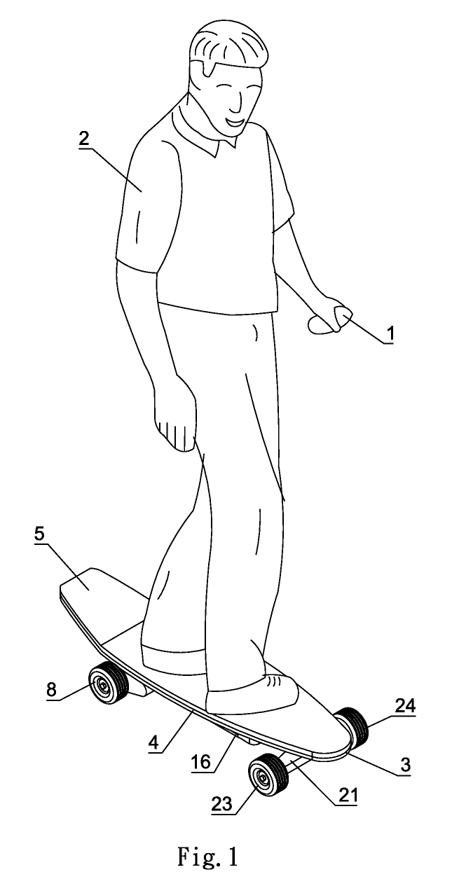

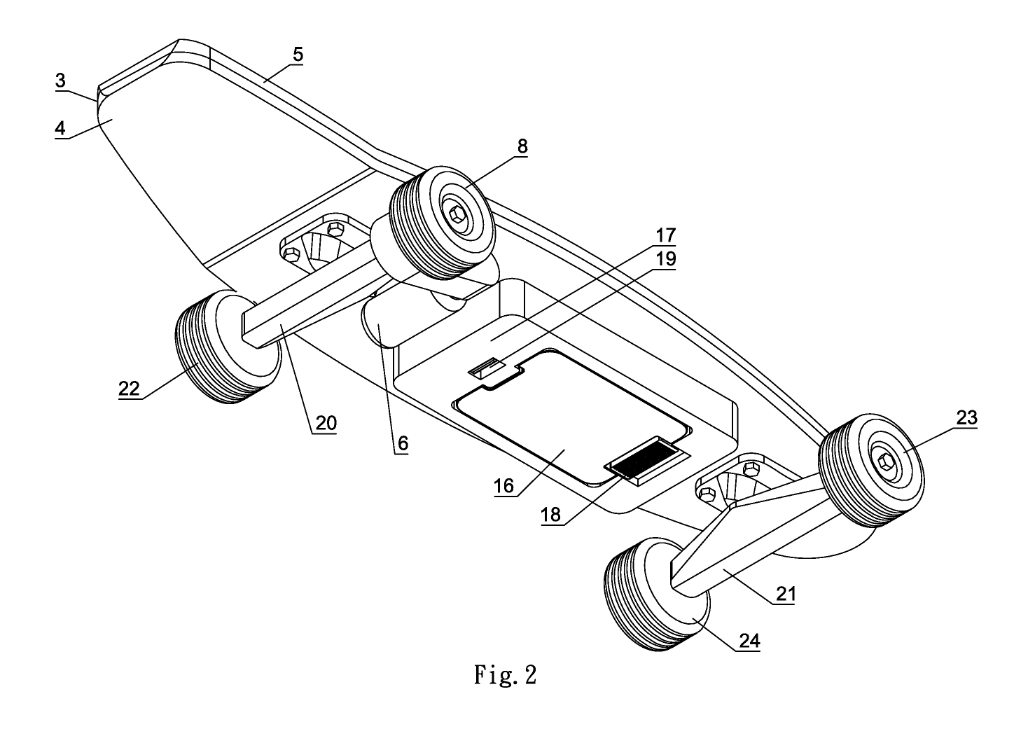

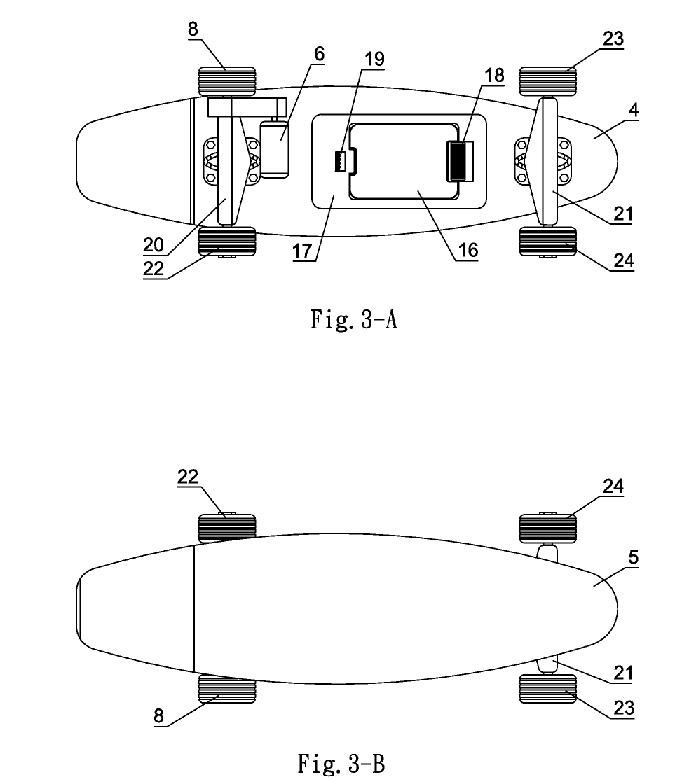

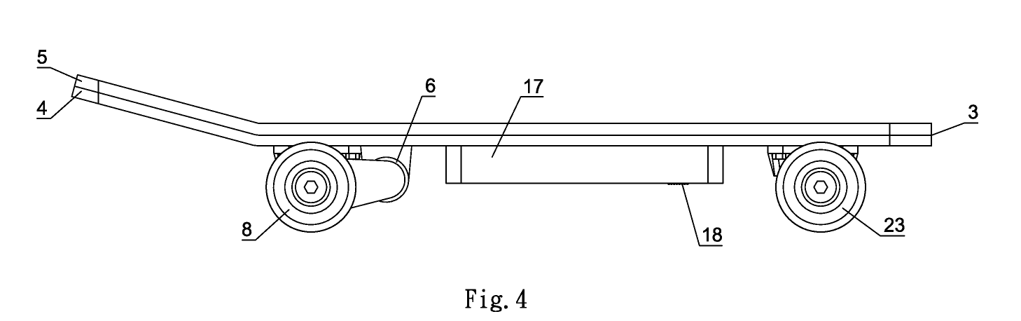

FIG. 1 shows a first preferred embodiment of the present invention. A rider 2 with a remote control 1 stands on a skateboard (as shown in FIG. 2). More detailed structures could be illustrated in FIGS. 2 to 4. The skateboard comprises a regular plywood 3 disposed at an upper portion thereof. As it should be, the plywood 3 could be made of other materials, like a polymer filled with glass. Herein, the plywood 3 has an upper rider-support surface 5 and a lower surface 4 supporting a front support 21, a plurality of passive wheels 23, 24, a rear support 20, a active wheel 8, and a passive wheel 22. Also, a transmitting apparatus, namely, a brushless motor 6, a controller 17, and a battery box 16 with Li-ion battery are all included in the present invention.

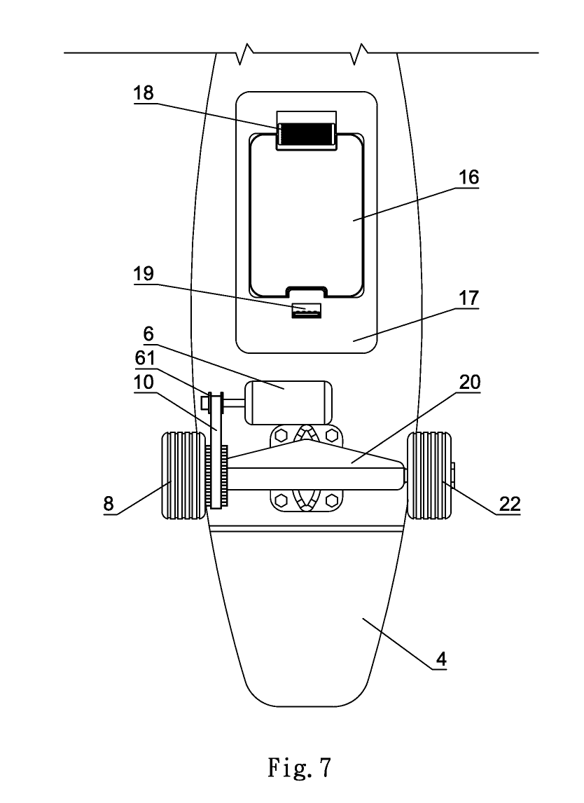

Referring to FIGS. 2 and 7, the electric powered skateboard has a synchronizing wheel 61 installed on a rotor of the brushless motor 6. Herein, by means of a synchronizing tape 10, the active wheel 8 could be directly rotated. That is to say, the operation of the brushless motor 6 permits a direct rotation of the active wheel 8 to be brought about by the synchronizing tape 10. Herein, the transmission between the active wheel 8 and the brushless motor 6 is so-called rolling without slipping. Such rolling offers the present invention a specific characteristic, that is, the active wheel 8 has an immediate braking force when an electrical braking is provided by the counter torque from the brushless motor 6. The strength of the braking force could be determined according to rider's desire. Herein, the skateboard is guaranteed to be stopped under the speed of 25 mph within a secure distance while an adult rider is standing on the skateboard. The brushless motor 6 adopts the high speed permanent magnet synchronous brushless motor or brushless hub motor, whose highest speed achieves 5100 RPM. Such motor is characterized as the high efficiency that no brush motor could achieve. Moreover, the efficiency of the abovementioned motor would not lessened even if the temperature is soaring; concurrently, in view of the obverse and reverse rotation provided therewith, the braking force thereof could be preferably adjusted. Thus, the braking of the skateboard is achieved by a controlled braking, rather than merely achieved by simply shutting off the brushless motor 6.

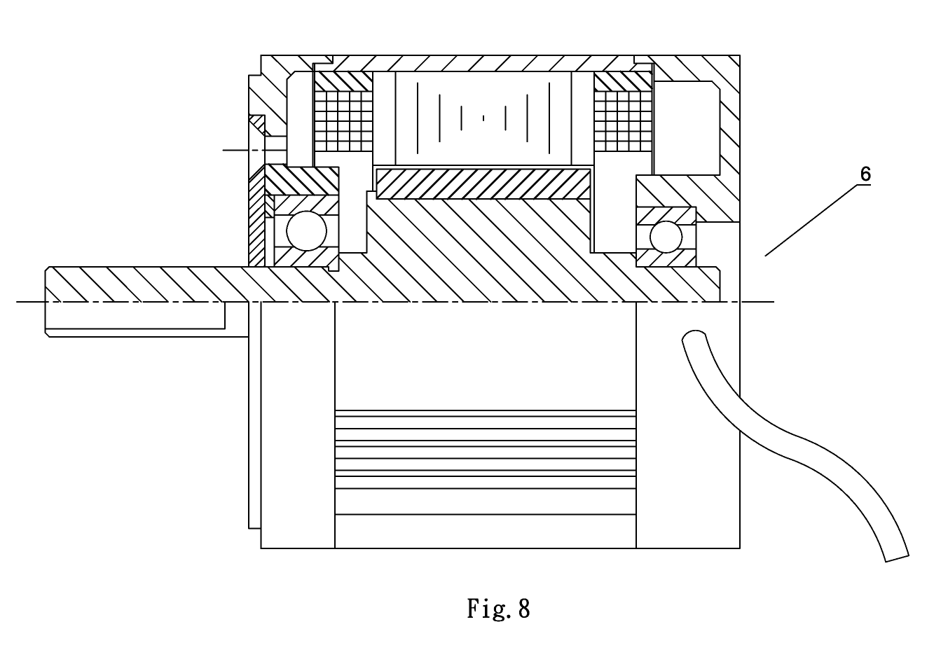

Referring to FIG. 8, the controller 17 permits the brushless motor 6 to accomplish various actions. Herein, the controller 17 is directed to a speed controlling device having the digital tuner. Wherein, the controller provides with the blockage protection, the cruise, the dynamic phase-lacking protection, and the fall-out prevention. The fall-out prevention takes effect while rider could not control the skateboard accidentally. Namely, if some part in the controller ceases to be effective, the controller would thence detect the unusual event, thereby the power supply would be cut off automatically. Obviously, the controller of the existing electric powered skateboard is unable to provide such automatic cutting-off function. Favorably, the present invention also provides a lower operating current that no conventional electric powered skateboard could offer. Thus, the using life of the battery adopted in the present invention is extendable. Moreover, since the controller 17 is in command of the remote control 1, the speed of the correspondent brushless motor 6 is accordingly decided by the different signals, including the acceleration, cruise, deceleration, and braking, transmitted from the remote control 1. Thus, the skateboard could accomplish various actions by means of the rider pressing different touch switches or triggering the potential sliding stem disposed on the remote control 1.

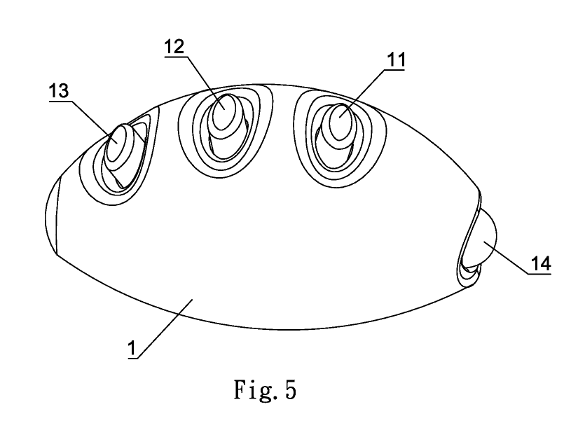

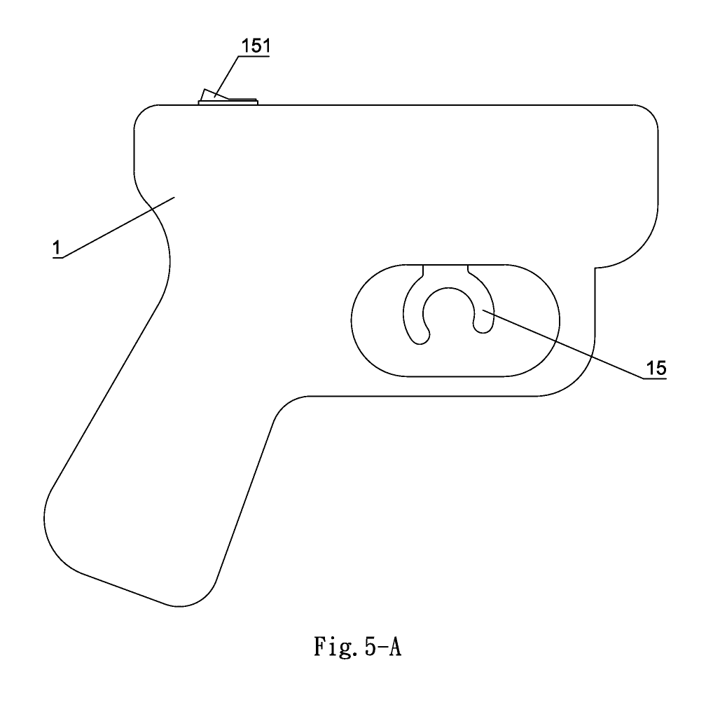

Referring to FIGS. 5 and 5-A, the remote control 1 comprises a power supply and a remote PCB. Different touch switches on the remote control 1 provide divergent control signals for the controller 17. Four buttons, the accelerating cruise button 11, the decelerate button 12, the reverse button 13, and the brake button 14, are provided on the remote control 1. While the accelerating cruise button 11 is clicked, the skateboard would move with a uniform velocity. The velocity of the skateboard is decided by the clicking times on the button. As a result, while rider feels a certain velocity is suitable, the accelerating cruise button 11 would be released, and then the operation of cruise would start. Herein, if rider continuingly presses the accelerating cruise button, the velocity of the skateboard would be steplessly increased until the desired velocity is achieved. The limiting speed of the skateboard is commonly regulated by the local statute. The decelerate button 12 has a similar function to that of the accelerate button 11. The slight difference between abovementioned two buttons is one is disposed for accelerating and the other is disposed for decelerating. Pressing the reverse button 13 would back the skateboard, and pressing the brake button 14 would stop the skateboard in a short time. Alternatively, the remote control 1 adopts a potential sliding stem to emit the control signals to the controller 17. The potential sliding stem includes a sliding buckle 15 who provides the skateboard with an average velocity in time of rider's finger clutching the buckle rearward. The velocity of the skateboard is decided according to a displacing amount of the clutching. If a desired speed of the skateboard is reached, rider would not clutch the buckle anymore for reducing the speed thereof. Moreover, a backing motion of the skateboard could be accomplished by a reverse clutching from the rider. Thus, when the sliding buckle is moved outward to a certain angle, a brake motion of the skateboard would be triggered and the skateboard would be stopped in a short time. If rider wants to back the skateboard, the back switch 151 on the top portion of the remote control would be triggered, so that the skateboard could go backwards according to the similar procedure as mentioned above.

The battery box 16 offers the power supply for the electric powered skateboard. The battery box 16 includes a bottom surface and two side surfaces. Moreover, a first groove is defined on the bottom of the battery box 16 for intercommunicating and justly fitting with a second groove defined on the skateboard while installing the battery box. A power socket 19 on the battery box connected to the controller 17 is defined for tightly engaging with a plug on the controller. Thus, the preferable electric conduction could be ensured. A secure lock 18 is disposed inside the battery box 16 for preventing the battery box 16 from sliding on the skateboard. One set of Li-ion battery is included in the battery box, and at least one set of the Li-ion battery adopting the voltage of 12V˜36V is provided according to the practical skateboard. As a result, under the same electric capacity, the Li-ion battery has a smaller size, lighter weight, and more effective as well as longer discharging time. Thus, the using life of the Li-ion battery is as 8 to 10 times as that of the lead-acid battery. Consequently, in view of the advantages contained in the Li-ion battery, the skateboard of the present invention could be ensured by a high quality.

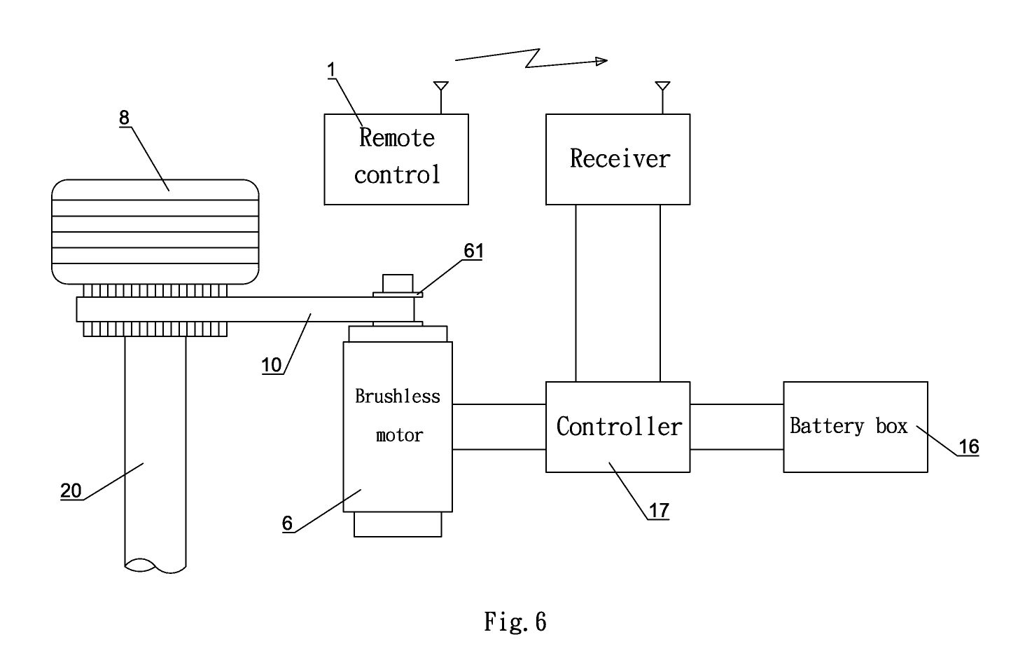

FIG. 6 shows a controlling flowchart of the brushless motor 6. The entire system of the skateboard comprises the remote part, the receiving and controlling part, the power supply part, and the brushless motor part. Under the condition that the power supply is provided, the electricity would be previously offered to the controlling part and the brushless motor part. Namely, while the remote control 1 is electrified and the skateboard is turned on, the remote control 1 would automatically emit an initial code for the receiver in the controller 17 to spontaneously distinguish and lock the initial code. In the meantime, no other remote control would be able to control the controller. Subsequently, while turning off the remote control 1, an automatic decoding would be achieved. So that the self-acting comparison between the remote control and the controller could be accomplished. Thus, rider's safety could be more assured, and the disadvantageous generated from the conventional remote control electric powered skateboard could be conquered. The receiver installed in the controller 17 receives the signal emitted from the remote control 1, and then the controller would decode the signal for further transmitting distinct commands to the brushless motor. As a result, the skateboard is able to implement multi actions according to the control signals from the remote control 1. Herein, the remote control 1 and the controller 17 are able to intercommunicate and control with each other through dual frequencies. For example, the 2.4G WIFI high frequency is applied for communication and range finding, and the low frequency is applied for controlling the motor and the controller 17. Thus, the two-way encoding of the dual communication is beneficial for ensuring the one-to-one communication, so that the remote control and the controller would not be interfered by external magnetic field or other radio wave. At least two brushless motors 6 disposed in accordance with the active wheel 8 and remnant passive wheel 22 (passive wheels 23, 24) collectively form a multi-driving motor system. Moreover, an electrical differential device is disposed in the controller 17 for synchronizing rotations of the four wheels.

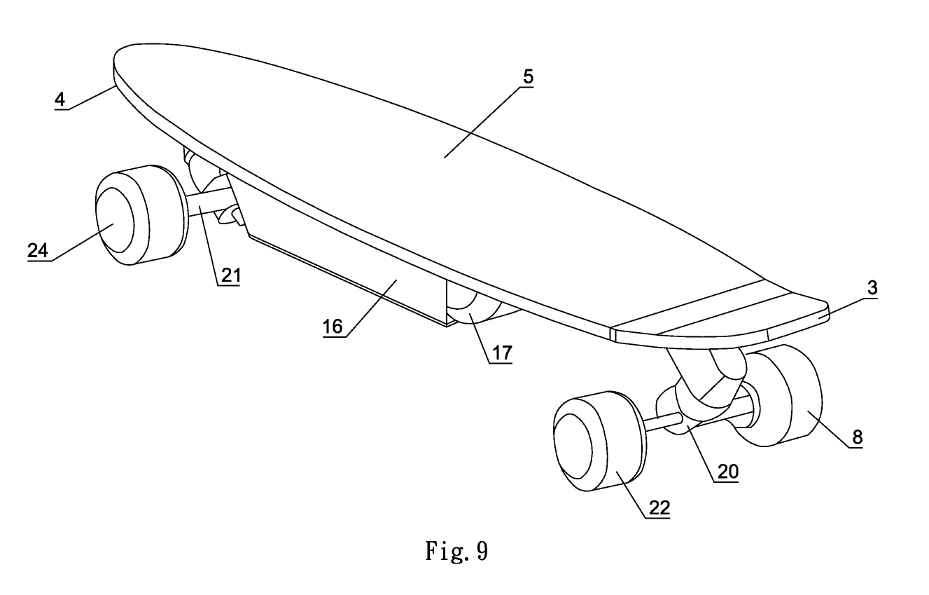

Referring to FIG. 9, another preferred embodiment of the present invention is shown. The structure in this embodiment is similar to that of the afore embodiment; a slight difference between these two embodiments is that the brushless motor 6 and the synchronizing wheel 61 as well as the synchronizing tape 10 are substitute by the brushless hub motor 7. The related structure is described as follows:

At least one active wheel 8 is directly connected to the brushless hub motor 7. Namely, the rotation of the brushless hub motor 7 directly transmits its operation to the active wheel 8 via the rotor. Herein, since the rotor is employed, the transmission manner between the active wheel 8 and the brushless hub motor 7 is directed to a rotation without slipping. Such rotation offers the present invention a specific characteristic; that is, the active wheel 8 has an immediate braking force when an electrical braking is provided by the counter torque from the brushless hub motor 7. The brushless hub motor 7 adopts the high speed permanent magnet synchronous brushless hub motor, whose highest speed achieves 5100 RPM. Such motor is characterized as the high efficiency that no brush hub motor could achieve. Moreover, the efficiency of the above-mentioned motor would not lessened even if the temperature is soaring; concurrently, in view of the obverse and reverse rotation provided therewith, the braking force thereof could be preferably adjusted.

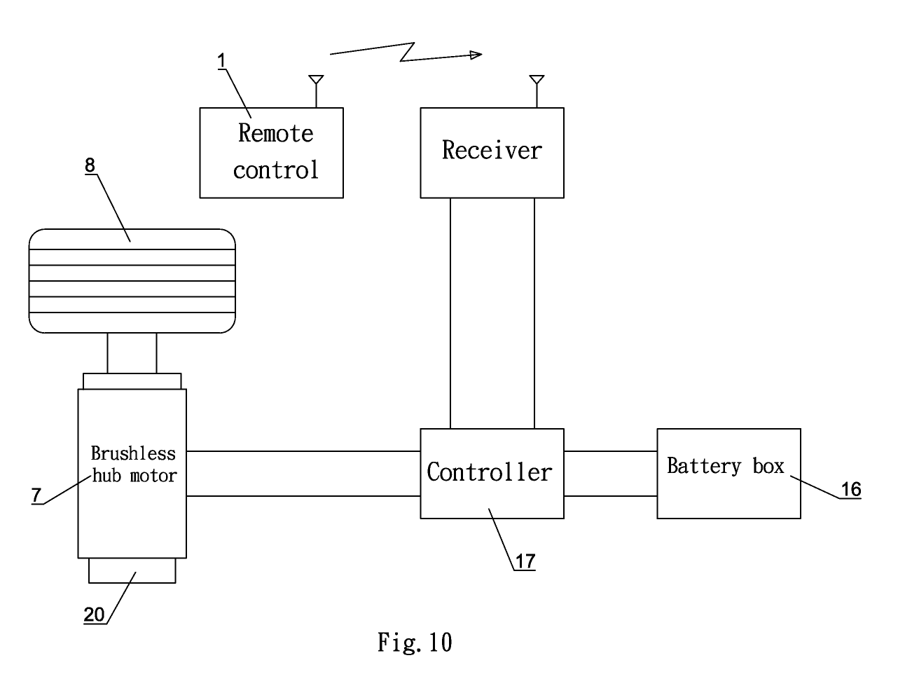

FIG. 10 shows a controlling flowchart of the brushless hub motor 7. The entire system of the skateboard comprises the remote part, the receiving and controlling part, the power supply part, and the brushless motor part. Under the condition that the power supply is provided, the electricity would be previously offered to the controlling part and the brushless hub motor part. Namely, while the remote control 1 is electrified and the skateboard is turned on, the remote control 1 would automatically emit an initial code for the receiver in the controller 17 to spontaneously distinguish and lock the initial code. In the meantime, no other remote control would be able to control the controller. Subsequently, while turning off the remote control 1, an automatic decoding would be achieved. So that the self-acting comparison between the remote control and the controller could be accomplished. Thus, rider's safety could be more assured, and the disadvantageous generated from the conventional remote control electric powered skateboard could be conquered. The receiver installed in the controller 17 receives the control signals emitted from the remote control 1, and then the controller would decode the signal for further transmitting distinct commands to the brushless hub motor 7. As a result, the skateboard is able to implement multi actions according to the control signals from the remote control 1. The remote control 1 and the controller 17 are able to intercommunicate and control with each other through dual frequencies. For example, the 2.4G WIFI high frequency is applied for communication and range finding, and the low frequency is applied for controlling the motor and the controller 17. Thus, the two-way encoding of the dual communication is beneficial for ensuring the one-to-one communication, so that the remote control and the controller would not be interfered by external magnetic field or other radio wave. At least two brushless motors 6 disposed in accordance with the active wheel 8 and remnant passive wheel 22 (passive wheels 23, 24) collectively form a multi-driving motor system. Moreover, an electrical differential device is disposed in the controller 17 for synchronizing rotations of the four wheels.

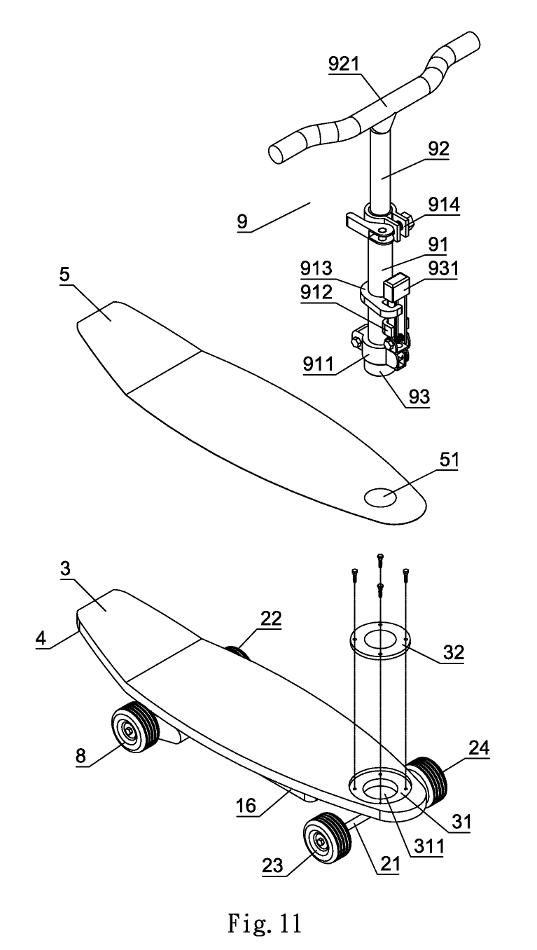

Referring to FIG. 11, another preferred embodiment of the present invention is shown. This embodiment utilizes the structure of afore electric powered skateboard. An auxiliary remote device 9 is disposed on the joint between passive wheel 21 and the plywood 3. The related structure is described as follows:

The plywood 3 combined with the front support 21 defines an indentation 31 whose center further provides with an opening 311. A strengthening block 32 is fitted in the indentation 31 so as to reinforce the construction, and a through hole 51 is defined on a front section of the upper rider-support surface 5 for being engaged with a base 93 disposed at the bottom of the auxiliary remote device 9. The auxiliary remote device 9 has an outer pipe 91 whose external surface further provides with a limiting seat 912 and a join member 913 at an appropriate position thereof. A limiting member 911 positioned at an extensive bottom of the outer pipe is properly superimposed on the base 93 with a pivotal engagement therein, so that the outer pipe is capable of slanting to the surface of the skateboard until parallelly lying thereon. A limiting stem 931 pivotally disposed at an external section of the base 93 is able to insert into the limiting seat 912 and the join member 913 for standing thereon. A locating device 914 is disposed on a top portion of the auxiliary remote device. The locating device includes an inner pipe 92 inward extensively disposed thereon; the inner pipe 92 could be telescopically adjustable to any suitable length. A remote handle 921 is further extensively connected to a top portion of the inner pipe 92. Herein, the operating principle and the controlling manner of the remote handle 921 are similar to those of the remote control 1, so that the tyro riders could still preferably learn the skill of riding the electric powered skateboard.

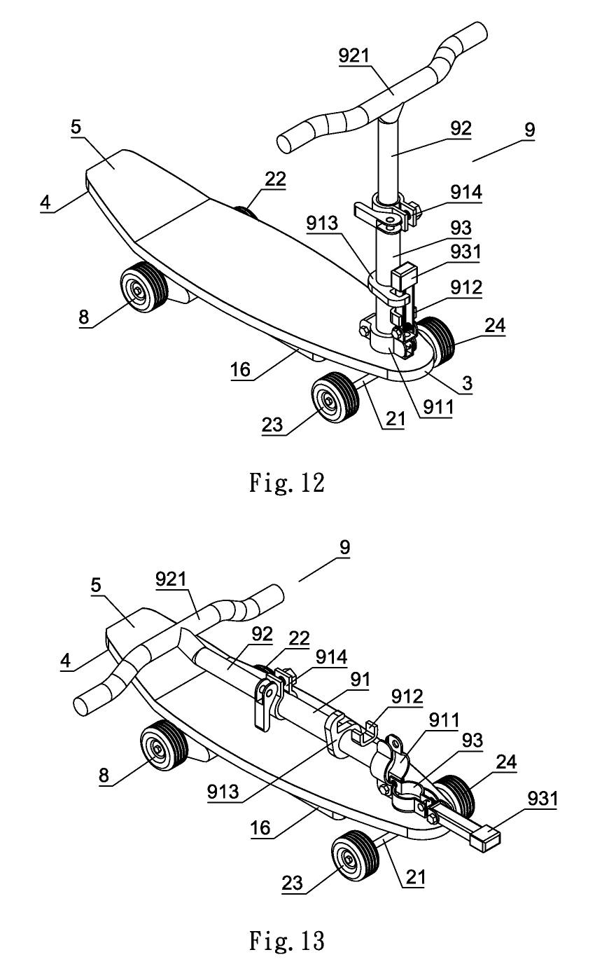

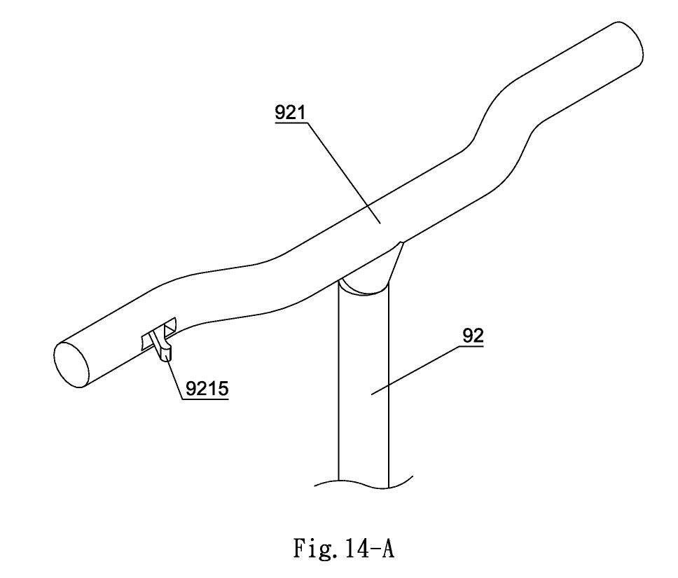

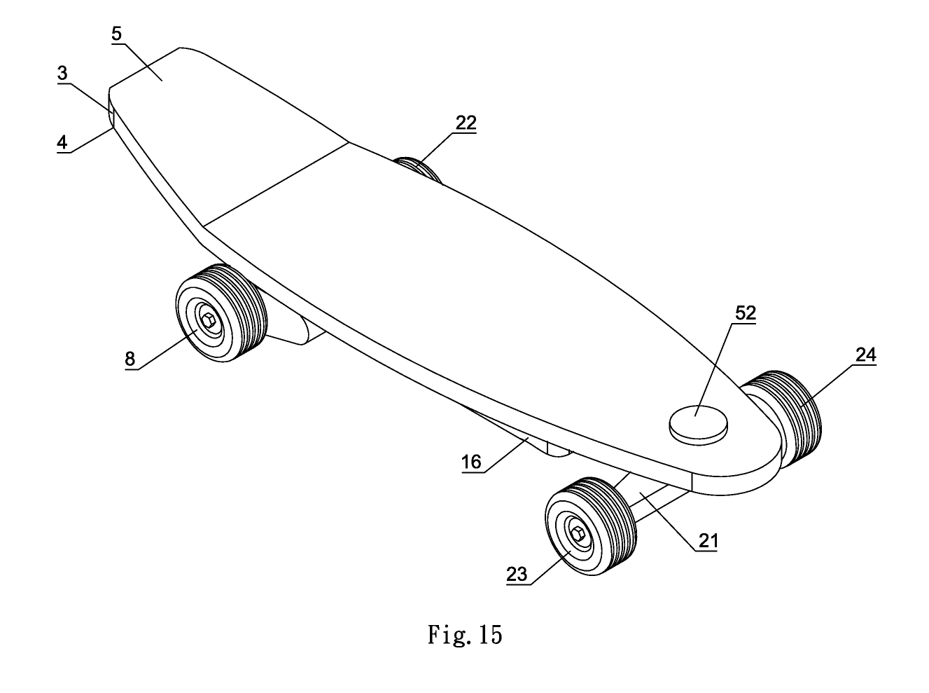

Referring to FIGS. 12, 13, and 15, in structuring, a cover 52 disposed on the through hole 51 and the opening 311 would be firstly removed for the base 93 of the auxiliary remote control 9 to penetrate the through hole 51 and the opening 311 to insert into the strengthening block 32. Accordingly, the locating device 914 would be untied for the inner pipe 92 to be stretched to an appropriate length, and after that the locating device 914 would be fixed, so that the rider could place hands on the corresponding remote handle to stand on the skateboard for operating. In folding, the join member 913 is wound for departing from the limiting stem 931, so that the limiting stem 931 could be axially moved onward. Whereby, the inner pipe 92 brought by the outer pipe 91 slants to the surface of the skateboard until parallelly lying thereon. If rider desires to resume the skateboard for using, adverse operating steps to abovementioned procedure should be adopted. As a result, the skateboard is handy for being taken along with the rider, or convenient for being accommodated. Preferably, while resuming the skateboard, the auxiliary remote device 9 could be simply drawn out for the cover 52 to further dispose on the through hole 51 and the opening 311, so that the skateboard could be controlled by the remote control 1.

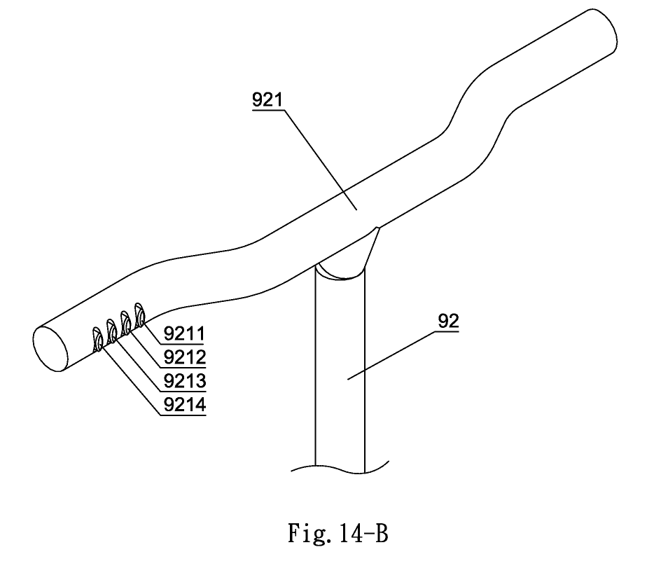

Referring to FIGS. 14-A and 14-B, the remote handle 921 comprises a power supply and a remote PCB. Different touch switches on the remote handle 921 provide divergent control signals for the controller 17. Four buttons, the accelerating cruise button 9211, the decelerate button 9212, the reverse button 9213, and the brake button 9214, are disposed on the remote handle 921. While the accelerating cruise button 9211 is clicked, the skateboard would move with a uniform velocity. The velocity of the skateboard is decided by the clicking times on the button. As a result, while rider feels a certain velocity is suitable, the accelerating cruise button 9211 would be released, and then the operation of cruise would start. Herein, if rider continuingly presses the accelerating cruise button 9211, the velocity of the skateboard would be steplessly increased until the desired velocity is achieved. The limiting speed of the skateboard is commonly regulated by the local statute. The decelerate button 9212 has a similar function to that of the accelerate button 9211. The slight difference between abovementioned two buttons is one is disposed for accelerating and the other is disposed for decelerating. Pressing the reverse button 9213 would back the skateboard, and pressing the brake button 9214 would stop the skateboard in a short time. Alternatively, the remote handle 921 adopts a potential sliding stem to emit the control signals to the controller 17. The potential sliding stem includes a sliding buckle 9215 which provides the skateboard with an average velocity in time of rider's finger clutching the buckle rearward. The velocity of the skateboard is decided according to a displacing amount of the clutching. If a desired speed of the skateboard is reached, rider would not clutch the buckle anymore for reducing the speed thereof. Moreover, a backing motion of the skateboard could be accomplished by a reverse clutching from the rider. Thus, when the sliding buckle 9215 is moved outward to a certain angle, a brake motion of the skateboard would be triggered and the skateboard would be stopped in a short time.

While we have shown and described the embodiment in accordance with the present invention, it should be clear to those skilled in the art that further embodiments may be made or modified without departing from the scope of the present invention.

I claim:

1. A remote control electric powered skateboard having a board with an upper rider-support surface and a lower surface supporting a plurality of wheels, characterized in that:
a brushless motor installed on said lower surface of said skateboard connecting to a battery device that provides said brushless motor with a driving power through a controller; a driving device being disposed between said brushless motor and at least one of said wheels; said driving device being controlled by a remote control and being able to offer an automatic comparison function; said remote control subjected to electrification allowing an automatic generation of an initial code for permitting a receiver in said controller to execute a spontaneous identification and automatically lock said initial code; an automatic decoding being carried on after said remote control being shut off; said receiver receiving control signals emitted from said remote control, said controller thence decoding said signals so as to dispatch distinct commands to said brushless motor, thereby allowing various actions pursuant to said signals emitted from said remote control to be implemented by said skateboard; at least three touch switches disposed on said remote control respectively controlling an accelerating cruise, a decelerating cruise, and a brake of said brushless motor; said brushless motor utilizing an instant obverse-reverse rotation characteristic to trigger said brake; while a braking signal being emitted from said remote control, said controller would thence emit a counter current to said brushless motor, so that said brushless motor having a braking function equivalent to a reverse rotation.

2. The skateboard as claimed in claim 1, wherein, in said remote driving device, at least one active wheel is connected to a synchronizing wheel on said brushless motor via a synchronizing tape.

3. The skateboard as claimed in claim 1, wherein at least two brushless motors are disposed in accordance with an active wheel and other passive wheels to collectively form a multi-driving motor system; an electrical differential device is disposed in said controller for synchronizing rotations of said four wheels.

4. The skateboard as claimed in claim 1, wherein, said remote control, said controller, and said receiver are directed to a speed control device having a digital tuner.

5. The skateboard as claimed in claim 1, wherein, said remote control and said controller are able to intercommunicate and control with each other through dual frequencies.

6. The skateboard as claimed in claim 1, said remote control comprises a further touch switch which serves to control a reversing of said brushless motor.

7. The skateboard as claimed in claim 6, wherein, said four touch switches on said remote control are an accelerating cruise button, a decelerating button, a reverse button, and a brake button, respectively.

8. The skateboard as claimed in claim 1, wherein, said remote control adopts a potential sliding stem to emit said control signals to said controller; said potential sliding stem includes a sliding buckle whose displacement amount decides a self-velocity of said skateboard, whereby said skateboard attains an average velocity while said sliding buckle is clutched backward and a deceleration effect while said sliding buckle is moved forward to its original position; said sliding buckle moved frontward over a certain limited angle serves to trigger a brake motion.

9. The skateboard as claimed in claim 8, wherein, a back switch is disposed on a top portion of said remote control.

10. The skateboard as claimed in claim 1, wherein, said brushless motor adopts a high speed permanent magnet synchronous motor whose highest rotational speed is 950˜5100 RPM.

11. The skateboard as claimed in claim 1, wherein, said high speed permanent magnet synchronous motor possesses at least 75%˜95% horsepower energy and 12V˜36V voltage.

12. The skateboard as claimed in claim 1, wherein, said controller provides with safety assemblies including a blockage protection, a dynamic phase-lacking protection, and a fall-out prevention, etc.

13. The skateboard as claimed in claim 1, wherein, said controller would automatically emit a stop signal to stop said skateboard when said controller beyond a remote-control distance fails to receive said signals from said remote control; said effective remote-control distance between said remote control and said controller is within 3 meters.

14. The skateboard as claimed in claim 1, wherein, a battery box is disposed on said lower surface of said skateboard; said battery box includes a bottom surface and two side surfaces; a first groove is defined on the bottom of said battery box for intercommunicating and fitting with a second groove defined on said skateboard while installing said battery box; a power socket defined on said battery box connects to said controller and tightly engages with a plug on said controller.

15. The skateboard as claimed in claim 14, wherein, a secure lock is disposed inside said battery box.

16. The skateboard as claimed in claim 14, wherein, at least one set of Li-ion battery is included in the battery box.

17. The skateboard as claimed in claim 16, wherein, said Li-ion battery adopts the voltage of 12V˜36V.

18. A remote control electric powered skateboard having a board with an upper rider-support surface and a lower surface supporting a plurality of wheels, characterized in that:
a brushless hub motor installed on said lower surface of said skateboard connecting to a battery device that provides said brushless hub motor with a driving power through a controller; a driving device being disposed between said brushless hub motor and at least one of said wheels; said driving device being controlled by a remote control and being able to offer an automatic comparison function; said remote control subjected to an electrification allowing an automatic generation of an initial code for permitting a receiver in said controller to execute a spontaneous identification and automatically lock said initial code; an automatic decoding being carried on after said remote control being shut off; said receiver receiving control signals emitted from said remote control, and said controller thence decoding said signals so as to dispatch distinct commands to said brushless hub motor, thereby allowing various actions pursuant to said signals emitted from said remote control to be implemented by said skateboard; at least three touch switches disposed on said remote control respectively controlling an accelerating cruise, a decelerating cruise, and a brake of said brushless hub motor; said brushless hub motor utilizing an instant obverse-reverse rotation characteristic to trigger said brake; while a braking signal being emitted from said remote control, said controller would thence emit a counter current to said brushless hub motor, so that said brushless hub motor having a braking function equivalent to a reverse rotation.

19. The skateboard as claimed in claim 18, wherein, in said remote driving device, at least one active wheel is directly connected to said brushless hub motor.

20. The skateboard as claimed in claim 18, wherein at least two brushless motors are disposed in accordance with an active wheel and other passive wheels to collectively form a multi-driving motor system; an electrical differential device is disposed in said controller for synchronizing rotations of said four wheels.

21. The skateboard as claimed in claim 18, wherein, said remote control, said controller, and said receiver are directed to a speed control device having a digital tuner.

22. The skateboard as claimed in claim 18, wherein, said remote control and said controller are able to intercommunicate and control with each other through dual frequencies.

23. The skateboard as claimed in claim 1, said remote control comprises a further touch switch which serves to control a reversing of said brushless hub motor.

24. The skateboard as claimed in claim 23, wherein, said four touch switches on said remote control are an accelerating cruise button, a decelerate button, a reverse button, and a brake button, respectively.

25. The skateboard as claimed in claim 18, wherein, said remote control adopts a potential sliding stem to emit said control signals to said controller; said potential sliding stem includes a sliding buckle whose displacement amount decides a self-velocity of said skateboard displacing amount, whereby said skateboard attains an average velocity while said sliding buckle is clutched backward and a deceleration effect while said sliding buckle is moved forward to its original position; said sliding buckle is moved frontward to a certain limited angle serves to trigger a brake motion.

26. The skateboard as claimed in claim 25, wherein, a back switch is disposed on a top portion of said remote control.

27. The skateboard as claimed in claim 18, wherein, said brushless motor adopts a high speed permanent magnet synchronous motor whose highest rotational speed is 950˜5100 RPM.

28. The skateboard as claimed in claim 18, wherein, said high speed permanent magnet synchronous motor possesses at least 75%˜95% horsepower, and the voltage range of 12V˜36V.

29. The skateboard as claimed in claim 18, wherein, said controller provides with safety assemblies including a blockage protection, a dynamic phase-lacking protection, and a fall-out prevention, etc.

30. The skateboard as claimed in claim 18, wherein, said controller would automatically emit a stop signal to stop said skateboard when said controller beyond a remote-control distance fails to receive said control signals from said remote control; said effective remote-control distance between said remote control and said controller is within 3 meters.

31. The skateboard as claimed in claim 18, wherein, a battery box is disposed on said lower surface of said skateboard; said battery box includes a bottom surface and two side surfaces; a first groove is defined on the bottom of said battery box for intercommunicating and fitting with a second groove defined on said skateboard while installing said battery box; a power socket defined on said battery box connects to said controller and tightly engages with a plug on said controller.

32. The skateboard as claimed in claim 31, wherein, a secure lock is disposed inside said battery box.

33. The skateboard as claimed in claim 31, wherein, at least one set of Li-ion battery is included in the battery box.

34. The skateboard as claimed in claim 33, wherein, said Li-ion battery adopts the voltage of 12V˜36V.

35. A remote control electric powered skateboard having a board with an upper rider-support surface and a lower surface supporting a plurality of wheels, characterized in that:
a plywood combined with a front support defining an indentation whose center further provides with an opening; a strengthening block being fitted in said indentation, and a through hole being defined on a front section of said upper rider-support surface for being engaged with a base on a bottom of an auxiliary remote device; said auxiliary remote device having an outer pipe whose external surface further provides with a limiting seat and a join member located at an appropriate position thereof, from a bottom of which a limiting member being extendedly positioned to fitly superimpose on said base and pivotally engagement with an interior section thereof; a limiting stem being pivotally disposed at an external section of said base to longitudinally assembly with said limiting seat and said join member or remove from said limiting seat and said join member for achieving a foldable effect; a locating device being disposed on a top portion of said auxiliary remote device; an inner pipe upwardly extending from an interior of said locating device, and a remote handle being further extensively connected to a top portion of said inner pipe; said inner pipe being telescopically adjustable to any suitable length; a brushless motor or a brushless hub motor installed on a lower surface of said skateboard connecting to a battery device that provides either said motor with a driving power through a controller; a driving device being disposed between said brushless motor or said brushless hub motor and at least one of said wheels; said driving device being controlled by a remote control and being able to offer an automatic comparison function; said remote handle subjected to an electrification allowing an automatic generation of an initial code for permitting a receiver in said controller to execute a spontaneous identification and automatically lock said initial code; an automatic decoding being carried on after said remote handle being shut off; said receiver receiving control signals emitted from said remote handle, and said controller thence decoding said signal so as to dispatch distinct commands to said brushless motor, thereby allowing various actions pursuant to said signals emitted from said remote handle to be implemented by said skateboard; at least three touch switches disposed on said remote handle respectively controlling an accelerating cruise, a decelerating cruise, and a brake of said brushless motor or said brushless hub motor; said brushless motor or said brushless hub motor utilizing an instant obverse-reverse rotation characteristic to trigger said brake; while a braking signal being emitted from said remote control, said controller would thence emit a counter current to said brushless motor, so that said brushless motor having a braking function equivalent to a reverse rotation.

36. The skateboard as claimed in claim 35, wherein, a cover covers said through hole and said opening after removing said auxiliary remote device, which permits said electric powered skateboard to be operated by said remote control, thence achieving an all-purpose effect.

37. The skateboard as claimed in claim 35, wherein, said remote handle provides with a sliding buckle to control said accelerating cruise, said decelerating cruise, and said brake of said brushless motor or said brushless hub motor.

38. The skateboard as claimed in claim 35, at least two brushless motors are disposed in accordance with an active wheel and other passive wheels to collectively form a multi-driving motor system; an electrical differential device is disposed in said controller for synchronizing rotations of said four wheels.

39. The skateboard as claimed in claim 35, wherein, said remote handle, said controller, and said receiver are directed to a speed control device having a digital tuner.

40. The skateboard as claimed in claim 35, wherein, said remote control and said controller are able to intercommunicate and control with each other through dual frequencies.

41. The skateboard as claimed in claim 35, said remote handle comprises a further touch switch which serves to control a reversing of said brushless motor.

42. The skateboard as claimed in claim 41, wherein, said four touch switches on said remote control are an accelerating cruise button, a decelerate button, a reverse button, and a brake button, respectively.

43. The skateboard as claimed in claim 1, wherein, said remote handle provides with a sliding buckle to replace said accelerating cruise button, said decelerating cruise button, said reverse button, and said brake button.

44. The skateboard as claimed in claim 35, wherein, said brushless motor and said brushless hub motor adopt a high speed permanent magnet synchronous motor.

45. The skateboard as claimed in claim 35, wherein, said controller provides with safety assemblies including a blockage protection, a dynamic phase-lacking protection, and a fall-out prevention, etc.

46. The skateboard as claimed in claim 35, wherein, said controller would automatically emit a stop signal to stop said skateboard when said controller beyond a remote-control distance fails to receive said control signals from said remote control; said effective remote-control distance between said remote control and said controller is within 3 meters.

47. The skateboard as claimed in claim 35, wherein, a battery box is disposed on said lower surface of said skateboard; said battery box includes a bottom surface and two side surfaces; a first groove is defined on the bottom of said battery box for intercommunicating and fitting with a second groove defined on said skateboard while installing said battery box; a power socket defined on said battery box connects to said controller and tightly engages with a plug on said controller.

48. The skateboard as claimed in claim 47, wherein, a secure lock is disposed inside said battery box.

49. The skateboard as claimed in claim 47, wherein, at least one set of Li-ion battery is included in the battery box.

50. The skateboard as claimed in claim 48, wherein, said Li-ion battery adopts the voltage of 12V˜36V.
